(19) United States
(12) Patent Application Publication
(10) Pub. No.: US 2021/0370707 A1
(43) Pub. Date: Dec. 2, 2021

(54) ROLL WRAP WITH DIY PAPER BOW TEMPLATES ON REVERSE

(71) Applicant: Hallmark Cards, Inc., Kansas City, MO (US)

(72) Inventors: Gina Beth Hull, Olathe, KS (US); Theresa Rose Mitchell, Wichita, KS (US); Olivia Turner Butler, Leawood, KS (US); Paula Ann Evans, Eudora, KS (US)

(73) Assignee: Hallmark Cards, Inc., Kansas City, MO (US)

(21) Appl. No.: 17/337,230

(22) Filed: Jun. 2, 2021

Related U.S. Application Data
(60) Provisional application No. 63/033,796, filed on Jun. 2, 2020.

(51) Int. Cl. B44C 5/00; B44F 3/00

(52) U.S. Cl. CPC B44C 5/00; B44F 3/00

(57) ABSTRACT

The technology described herein relates to a design template overlaid on a surrounding series of grid cut lines on the back side of a roll of wrapping paper. Based on juxtaposition within the grid cut lines, the DIY design template cut lines may correspond directly or indirectly to at least a portion of the front side of the wrapping paper decoration. Accordingly, embodiments of the design template may include cut lines for various bow and/or accessory content that, once extracted from the surrounding wrapping paper, may be assembled into a coordinated bow or accessory featuring intentional placement of design content form the front side of the wrapping paper. Additionally, the design template pattern may be repeated along an axis of orientation of the roll of wrapping paper, such that multiple DIY design templates may be repeated across the entire roll wrap bundle.

### TECHNICAL FIELD

Aspects of the technology described herein relate to a decorative wrapping paper having integrated, do-it-yourself (DIY) design templates. In further aspects, the wrapping paper roll may include a front, decorated side and a back, template side having a DIY design template with instructions for creating a bow and/or accessory to coordinate with the decorative content elements on the reverse side. Such bow or accessory may facilitate a secondary use for at least a portion of the decorative wrapping paper, with grid cut lines on the back side of the wrapping paper guiding both straight-line wrapping and the extraction of particular, DIY template content.

### SUMMARY

This Summary is provided to introduce a selection of concepts in a simplified form that are further described below in the Detailed Description. This Summary is not intended to identify key features or essential components of the claimed subject matter, nor is it intended to be used as an aid in determining the scope of the claimed subject matter. The technology described herein generally relates to printed wrapping paper having a front side with a wrapping paper decoration, and a reverse side with a printed design template integrated into a series of grid cut lines, with the design template on the back side positioned with respect to at least one axis of orientation along the length of the wrapping paper.

Embodiments of the design template may include various content for facilitating a secondary use for the wrapping paper, in addition to wrapping a consumer gift, such as series of instructions and cutting guides for at least one DIY project. In further embodiments, the design template may include a supply list, instructions, and design (e.g., bow and accessory) cut lines depicted within at least a portion of the surrounding grid cut lines on the back side of the wrapping paper. Aspects of the design template may be designed specifically for use when wrapping an item with a separate portion of the same or similar decorated wrapping paper design, thus creating a coordinated accessory featuring the same or similar design elements as the wrapping paper.

In further aspects, embodiments of the technology described herein relate to a DIY design template overlaid in context with the surrounding series of grid cut lines on the back side of a roll of wrapping paper. Based on juxtaposition within the grid cut lines, the DIY design template cut lines may correspond directly or indirectly to at least a portion of the front side of the wrapping paper decoration. Accordingly, in some embodiments, the design template may include cut lines for various bow and/or accessory content that, once extracted from the surrounding wrapping paper, may be assembled into a coordinated bow or accessory featuring the intentional placement of design content from the front side of the wrapping paper. Additionally, the design template pattern may be repeated along an axis of orientation of the roll of wrapping paper, such that multiple DIY design templates may be repeated across the entire roll wrap bundle, similar to the repeated pattern of the front surface design.

Accordingly, the present disclosure relates to a roll wrap paper sheet comprising a first surface comprising at least one design element and a second surface opposite the first surface, wherein the second surface comprises a DIY project template for making at least one DIY project, wherein the DIY project template comprises at least one design template opposite at least a portion of the at least one design element, wherein the at least one design template comprises template cut lines that define a shaped area, and wherein the template cut lines are positioned relative to corresponding portions of the at least one design element such that portions of the design element are oriented in a pre-defined decoration position within the shaped area.

The present disclosure also relates to a gridded roll wrap comprising a first decorated surface and a second surface opposite the first decorated surface, the second surface comprising a plurality of grid lines, at least one design template, and instructions, wherein the at least one design template comprises a plurality of cut lines that define a plurality of shapes, and the instructions provide instructions for assembling the plurality of shapes into at least one project.

The present disclosure is further directed to a roll wrap templating system comprising a first set of printing content configured to imprint a design on a first side of a roll of paper, a second set of printing content configured to imprint a design template on a second side of the roll of paper, and a registration key configured to orient at least a portion of the first set of printing content with at least a portion of the second set of printing content such that the design template is oriented on the second side of the roll of paper relative to corresponding portions of the design on the first side of the roll of paper.

Also provided herein is a method of making a roll wrap paper sheet comprising creating a decoration for a first side of the roll wrap paper sheet, creating a DIY project template for a second side of the roll wrap paper sheet opposite the first side, wherein the DIY project template comprises alignment lines and at least one design template, wherein the alignment lines are positioned relative to the design template such that aligning the alignment lines in a pre-defined alignment position relative to the paper orients at least a portion of the at least one design template relative to corresponding portions of the decoration in a pre-defined decoration position, imprinting the first side of the roll wrap paper sheet with the decoration, and imprinting the second side of the roll wrap paper sheet with the DIY project template such that the alignment lines are positioned in the pre-defined alignment position relative to the paper sheet.

### BRIEF DESCRIPTION OF THE SEVERAL VIEWS OF THE DRAWINGS

The technology is described in detail below with reference to the attached drawing figures, wherein:

FIG. 1 depicts an exemplary roll wrap sheet with a DIY template, in accordance with aspects herein;

FIG. 2 depicts an enlarged view of a portion of the DIY template of FIG. 1, in accordance with aspects herein;

FIG. 3 depicts an enlarged view of a portion of the DIY template of FIG. 1, in accordance with aspects herein;

FIG. 4 depicts a series of exemplary, interchangeable bows made from a plurality of coordinated wrapping paper designs with coordinating template cut line patterns, in accordance with aspects herein;

FIG. 5 depicts a plurality of design templates for DIY construction of one or more bows and/or accessories in context of a cut line grid on a roll of wrapping paper, in accordance with aspects herein;

FIG. 6 depicts the bottom side of an exemplary roll wrap sheet with a DIY template, in accordance with aspects herein;

FIG. 7 depicts a three coordinated roll wrap sheets having DIY templates on the bottom side thereof, in accordance with aspects herein;

FIG. 8 depicts a roll wrap sheet having a DIY template on the bottom side, in accordance with aspects herein;

FIG. 9 is a top side view of an exemplary roll wrap sheet, having a folded portion revealing the bottom side having a DIY template;

FIG. 10 depicts a series of design pieces cut from the roll wrap sheet;

FIG. 11 is a perspective view of bows of varying sizes produced from roll wrap sheets having DIY templates according to the present disclosure;

FIG. 12 is a perspective view of a gift wrapped and having a bow produced from roll wrap sheets having DIY templates according to the present disclosure;

FIG. 13 is an exemplary template for the bottom side of a roll wrap sheet and completed project for an ornament;

FIG. 14A is an exemplary template for the bottom side of a roll wrap sheet and completed project for a gift box;

FIG. 14B is another exemplary template for the bottom side of a roll wrap sheet and completed project for a gift box;

FIG. 15A is another exemplary template for the bottom side of a roll wrap sheet for completing, for example, a paper chain project;

FIG. 15B is a perspective view of an exemplary paper chain project produced from the template of FIG. 15A;

FIG. 16 is an exemplary template for the bottom side of a roll wrap sheet to create a butterfly;

FIG. 17A is an exemplary template for the bottom side of a roll wrap sheet to create a paper airplane;

FIG. 17B is an exemplary instructions section for the bottom side of a roll wrap sheet to create a paper airplane from the template of FIG. 17A;

FIG. 18A is another exemplary template for the bottom side of a roll wrap sheet for completing, for example, a napkin ring project; and

FIG. 18B is a perspective view of a napkin ring produced from the template of FIG. 18A.

### DETAILED DESCRIPTION

Aspects of the technology described herein will become more apparent with reference to the figures provided herein. Embodiments of the roll wrap with DIY paper bow templates on reverse comprise instructions regarding supplies and how-to steps for multiple different bow sizes to be made from the wrapping paper, displaying the design on the reverse side upon following the back-side template instructions.

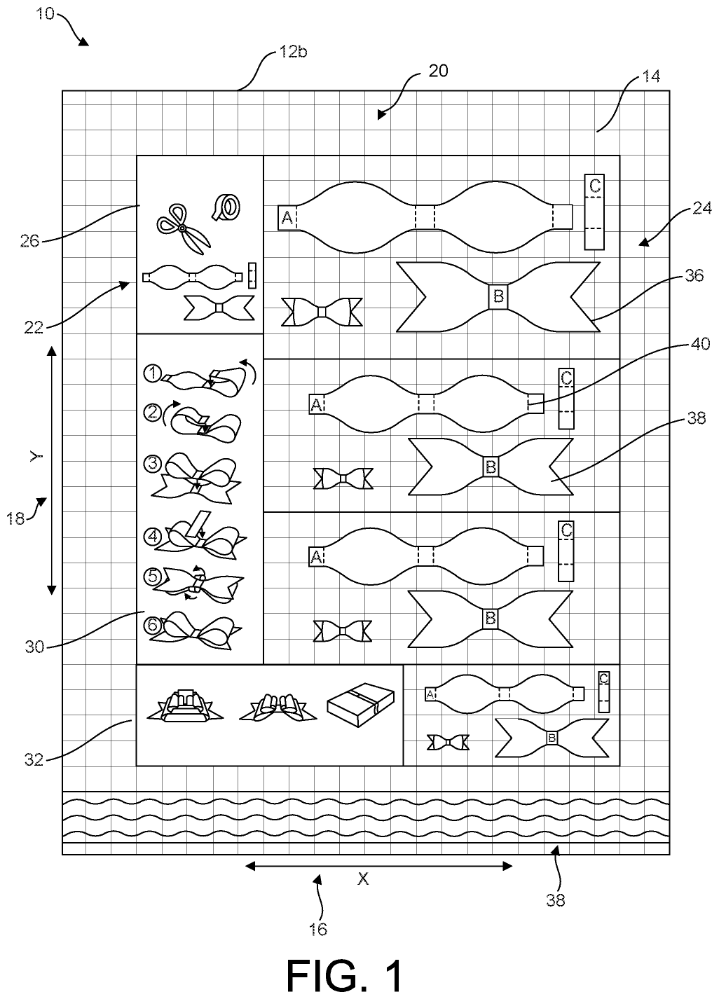

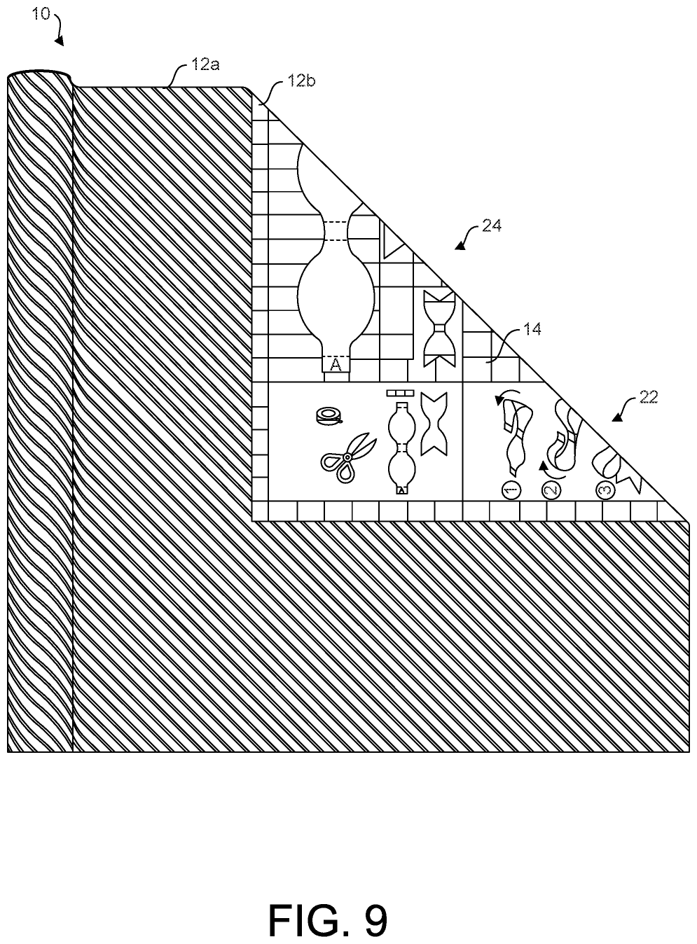

With reference initially to FIG. 1, a roll of gift wrap is generally indicated at reference numeral 10. The gift wrap roll 10 is a sheet of gift wrap having a top side 12a and a bottom side 12b (FIG. 9). The top side 12a of the gift wrap roll 10 can include any desired decorative design or color. For example, in some embodiments, the top side 12a of the gift wrap roll 10 includes a decorative design (e.g., polka dots, stripes, or other decorative illustrations) or a solid color.

The bottom side 12b of the gift wrap roll 10 includes a plurality of grid background cut lines 14 and a DIY design template 20. The DIY design template 20 comprises an instructions section 22 and a template section 24. In general, the template section 24 includes templates 36 for a DIY project using the gift wrap roll 10, and the instructions section 22 details any needed supplies, steps for creating the project, or any other relevant information.

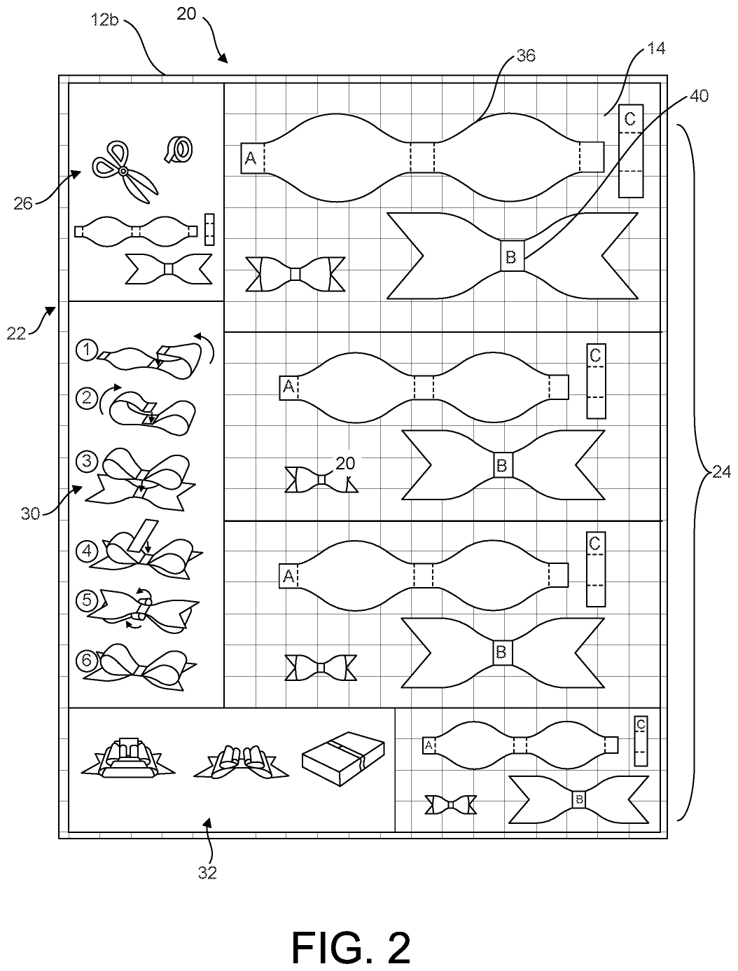

Grid cut lines 14 are present across a portion of the bottom side 12b. In preferred embodiments, grid cut lines 14 are present across the entire bottom side 12b of gift wrap roll 10. In this example, the wrap 10 is oriented along a horizontal (X) axis 16 and a vertical (Y) axis 18, and the gridded background cut lines 14 are visible in at least a portion of the DIY design template 20, as depicted in FIG. 2. Further, the horizontal grid lines 14 are aligned with X-axis 16 and the vertical grid lines 14 are aligned with Y-axis 18, and the horizontal and vertical lines intersect. In various embodiments, the background cut lines 14 may be visible in all portions of the DIY design template 20. Alternatively, the background cut lines 14 may not be visible in certain portions of the DIY design template 20 (e.g., the instructions section 22 and/or the template section 24).

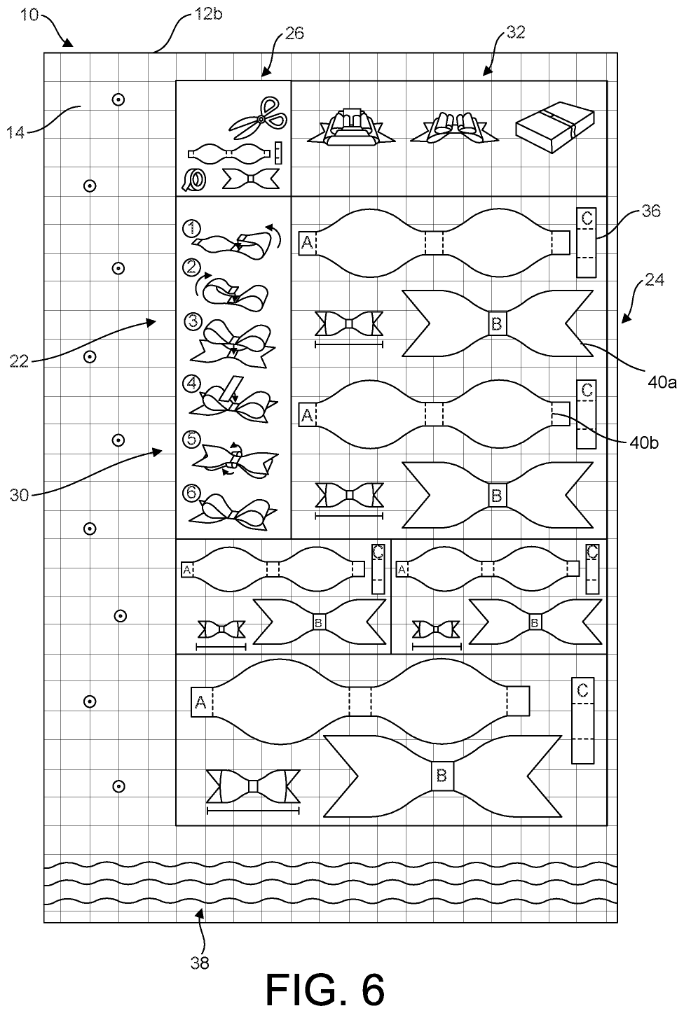

As mentioned above, the bottom side 12b of the gift wrap roll 10 includes an instructions section 22 within the DIY design template 20. The instructions section 22 includes a supplies list 26. Supplies list 26 indicates which items will be needed to carry out the DIY project. The instructions section 22 also includes an instructions list 30. The instructions list 30 provides a listing of steps to be completed by a user in order to achieve the end result (e.g., the final design/project 48 corresponding to one or more of the templates 36). The instructions section 22 also includes an informational section 32. The informational section 32 can include information guiding the user how to further utilize their DIY creations 48 (e.g., as a decorative feature, a gift wrap accessory, home accessory, fashion accessory, and the like). The informational section 32 can include further DIY instructions, directions, and/or accessories, and can direct the user to the accessory section 38. For example, the informational section 32 can refer to the accessory section 38. In the embodiment illustrated in FIGS. 1 and 2, the supplies list 26 is near the top portion of the Y-axis 18. The instructions section 30 is oriented below the supplies list 26 on the Y-axis 18. The informational section 32 is oriented below the instructions list 30 on the Y-axis 18. In this embodiment, the informational section 32 extends farther onto the X-axis 16 than the supplies list 26 and the instructions list 30. In another embodiment depicted in FIG. 6, the supplies list 26 is near the top portion of the Y-axis 18. The instructions section 30 is oriented below the supplies list 26 on the Y-axis 18. The informational section 32 is oriented adjacent the supplies list 26 on the X-axis 16. It will be understood that these sections can be oriented and sized/shaped as desired, and may be selected in such a way as to maximize space on the gift wrap roll 10 and/or to correlate templates 36 with design features on the front side 12a of the gift wrap roll 10.

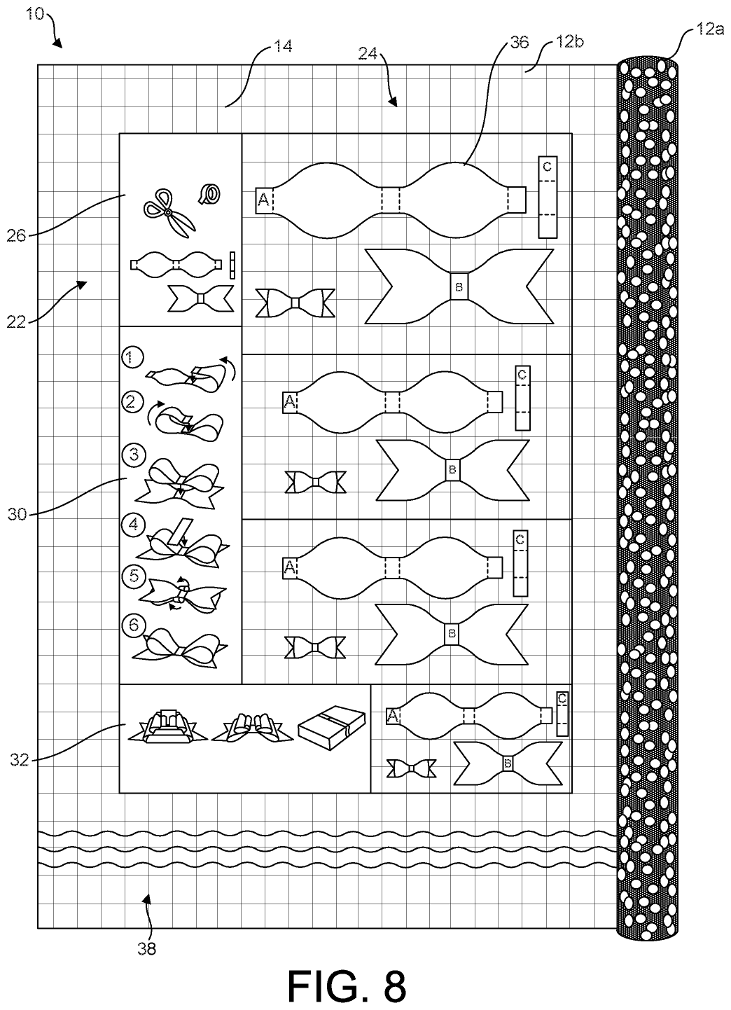

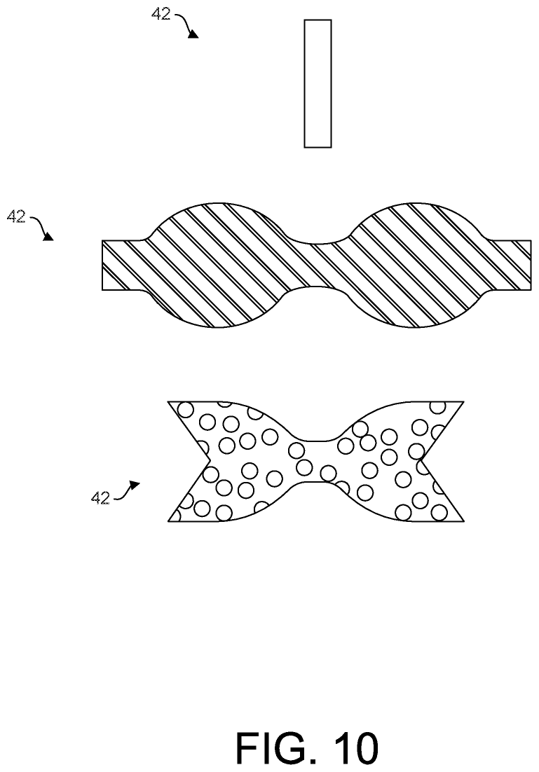

The template section 24 includes templates 36 to create at least one DIY project. In the illustrated embodiment, the template section 24 includes multiple templates 36 consisting of variable sizes of bow cut lines for creating multi-layered bows. Referring in particular to the templates exemplified in FIGS. 1, 2, 6, and 8, the template section 24 includes templates 36 for bows of three different sizes. Multiple design pieces 42 (FIG. 10) are required to construct each bow as illustrated and are provided in the template section 24. In particular, referring to FIG. 1, template section 24 includes three template pieces for making one large bow, six template pieces for making two medium bows, and three template pieces for making one small bow, although it will be understood that any combination of template sizes can be used. As another example, the template section 24 of FIG. 6 includes three template pieces for making one large bow, six template pieces for making two medium bows, and six template pieces for making two small bows. The instructions section 22 describes how to combine the template pieces to complete a DIY project. In particular, the supplies list 26 of the instructions section 22 lists the necessary supplies (e.g., particular template pieces, scissors, tape, glue, and the like), the instructions list 30 outlines the steps required to complete the bow project, and the informational section 32 includes information regarding ways to utilize the completed bow, for example, in gift wrap designs.

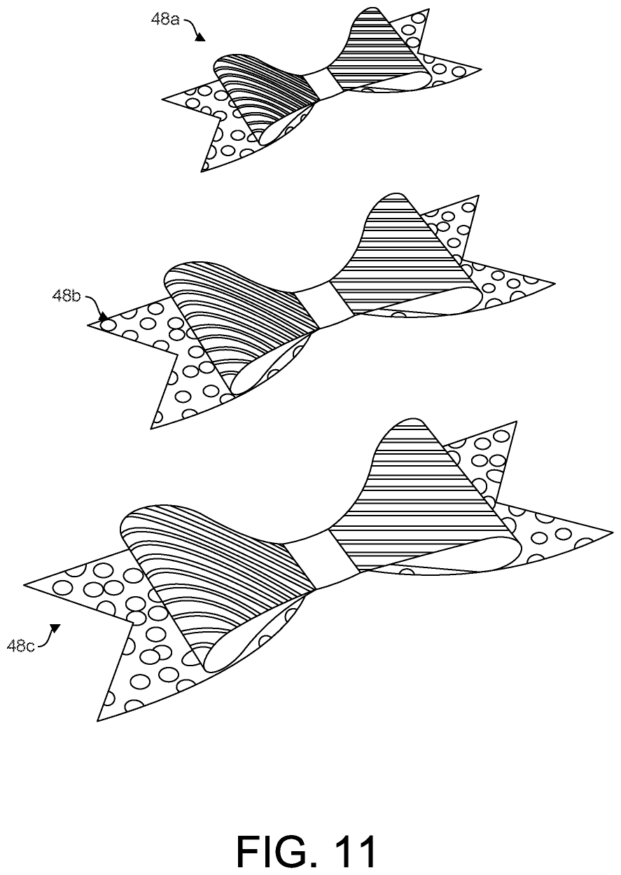

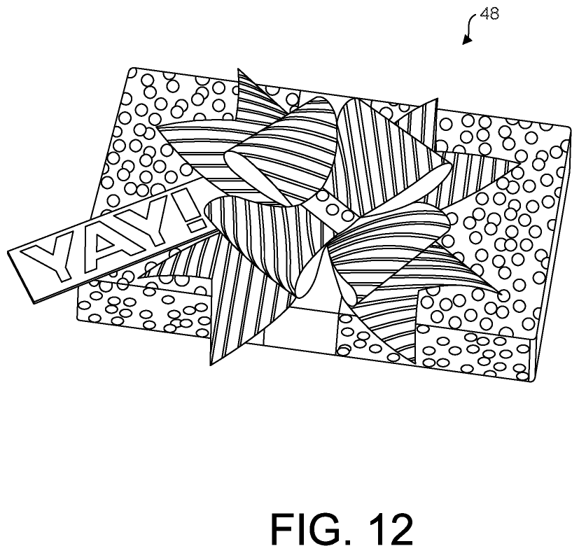

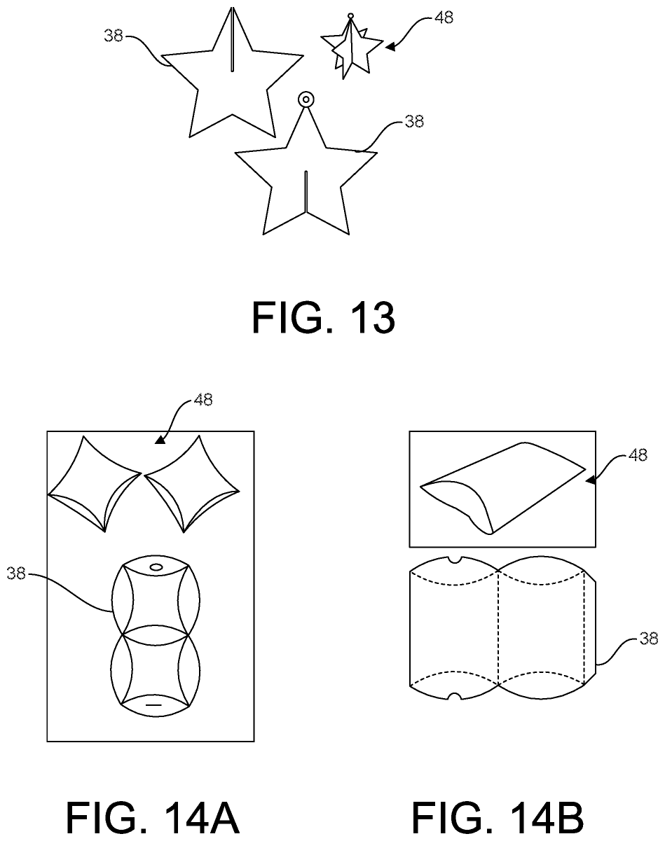

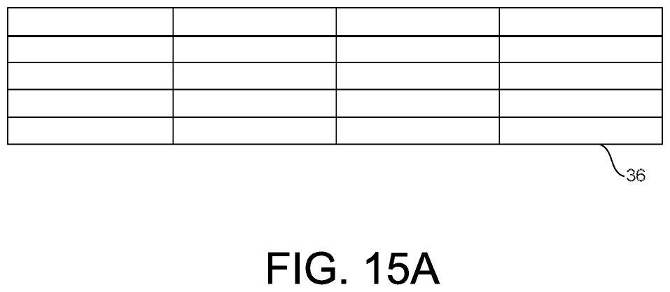

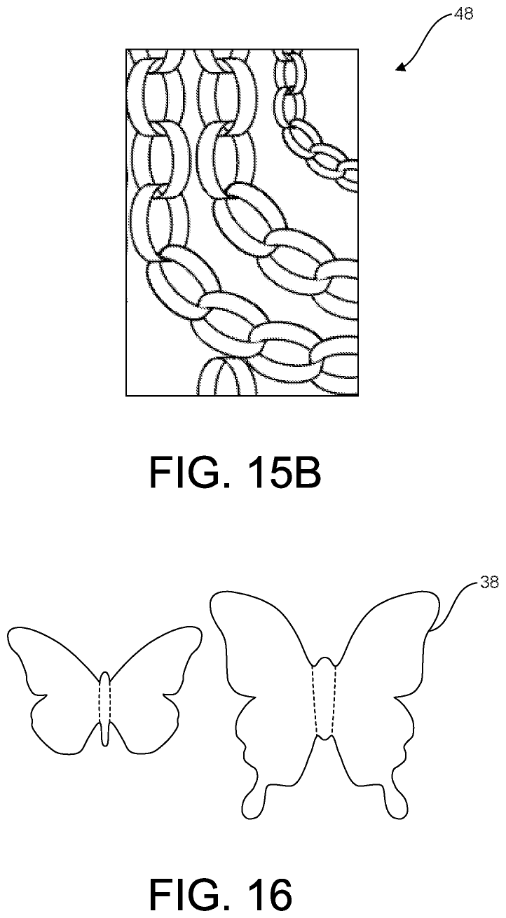

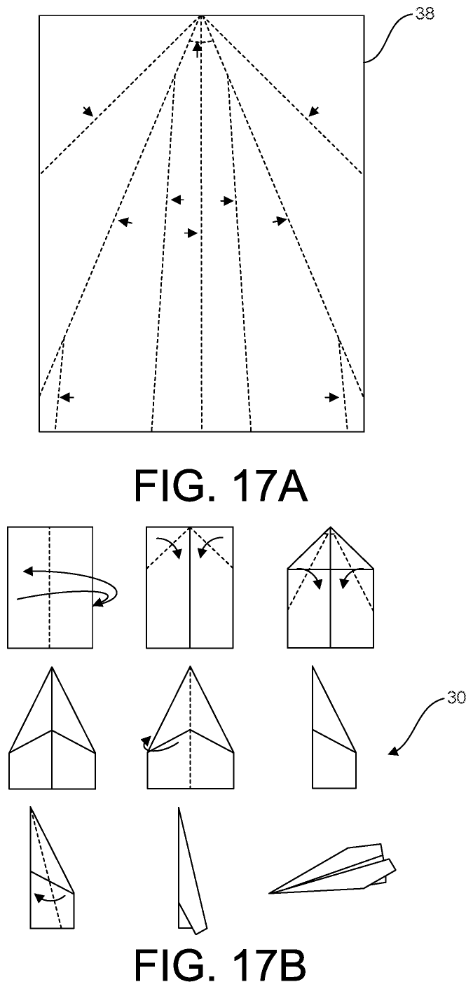

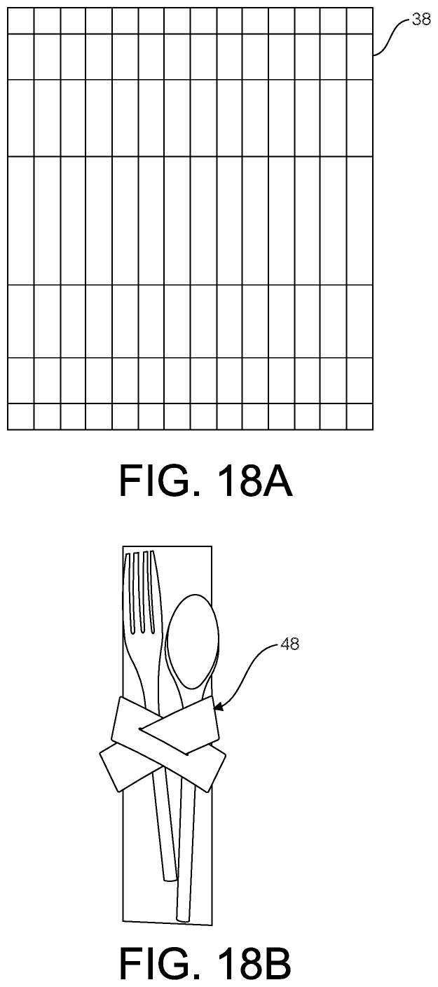

It should be understood that template section 24 could include templates 36 for creating various DIY projects. The DIY projects can include such things as gift wrap bows (FIG. 12), gift wrap strips (to decorate a gifted item by creating patterns, e.g., plaid patterns, or with instructions to provide a wrapped gift with no raw cut edges of the gift wrap showing), paper items (e.g., gift boxes (FIGS. 14A and 14B), gift bags, gift presenters, gift tags, gift cards, envelope liner insert templates, envelope templates, and the like), party items (e.g., napkin rings (FIGS. 18A and 18B), utensil holders/pouches, table runners, placemats, tablecloths, board games, dice games, other activities, party hats, party crowns, paper cones for flowers or food, fortune cookies, and the like), decor items (e.g., wall art, lettering and numbering, bunting, paper chains (FIGS. 15A and 15B), garlands, advent calendars, gingerbread houses, Christmas tree toppers, and the like), fashion accessories (e.g., hair accessories, necklaces, bracelets, and the like), other decorative items (e.g., airplanes (FIGS. 17A and 17B), ornaments (FIG. 13), stars, trees, flowers, butterflies (FIG. 16), and the like), and so forth, although it will be understood by the skilled person that the present disclosure is not limited to these items alone. In various embodiments, the templates 36 can create three-dimensional DIY projects. The templates 36 may also be provided in different sizes. For example, in the embodiment illustrated in FIG. 11, templates 36 are provided to create three different sizes of bows 48a, 48b, 48c. The bottom side 12b of the gift wrap roll 10 can also include features such as board games, coloring projects (scenes, characters, icons, and the like), small games (maze, word search, and the like), and so forth.

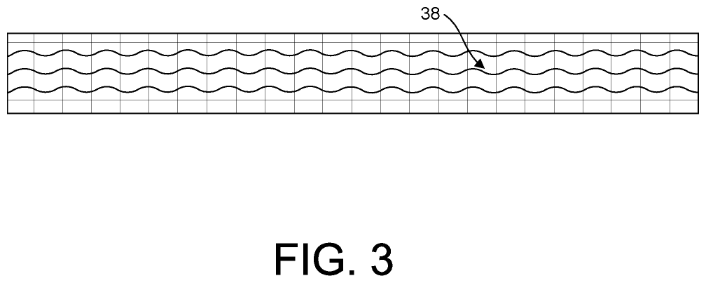

As will be understood, one or more different components, sections, instructions, guides, templates, cut-out shapes, accessories, tags, and gift accessories may be provided in association with a DIY design template 20, and the components depicted in FIGS. 1-3 are examples of some of the different types of content included within one exemplary DIY design template 24. The templates 36 therefore vary based on the DIY project to be created. Placement of templates 36 may vary on the X-axis 16 and the Y-axis 18 so that they coordinate with specific, decorative components of the top side 12a of the gift wrap roll 10, although this is not a requirement. That is, to facilitate the orientation of particular template content 36, either directly or indirectly, with the top side's 12a decorative paper content, the template content 36 may be oriented with respect to one or more of the X axis 16 and/or Y axis 18, as facilitated in context of the grid cut lines 14. Thus, as mentioned above, the informational, printed content of the instructions section 22 may, in some instances, obscure the grid cut lines 14, while the instructional, template content 36 may be depicted with solid cutting lines 40a around the perimeter of each template 36 and with the additional guidance of positioning from the grid cut lines 14 (FIG. 6). The template 36 can also be depicted with dotted lines 40b to indicate areas that may be folded during assembly of the DIY project. In practice, the user follows the instructions and cuts around solid cutting lines 40a to provide design pieces 42. Design pieces 42 can then be combined according to the instructions section 22 to provide a completed DIY project 48 (see FIGS. 12-14B, 15B, and 18B as examples).

The gift wrap roll 10 may also include instructions (for example, in the instructions section 22) on how to use the cardboard core of the gift wrap roll 10 in making different DIY projects, such as any of those listed above. Alternatively, instructions on utilizing the cardboard core may be separately provided.

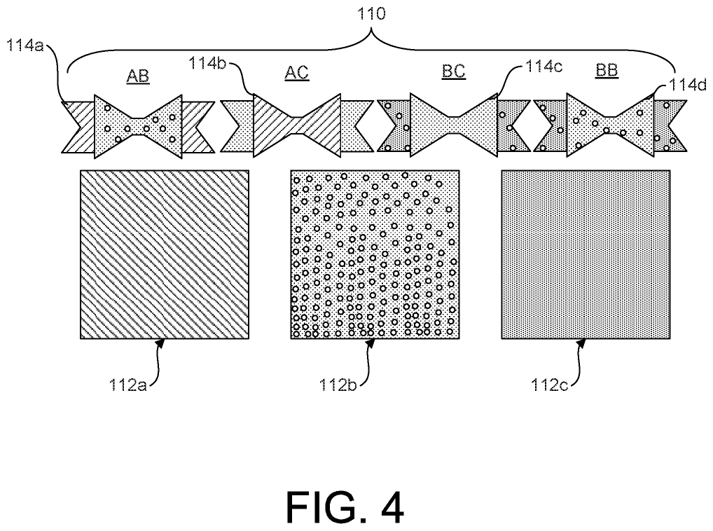

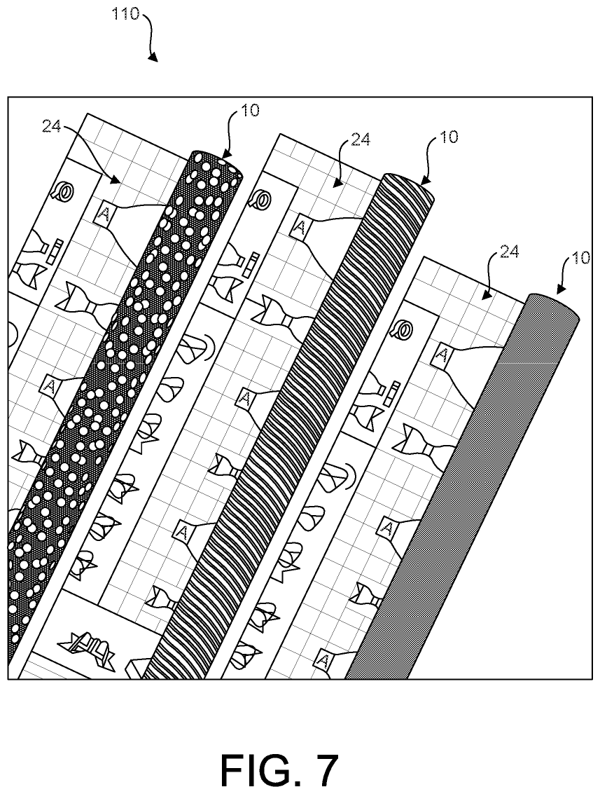

Turning next to the example of FIG. 4, an exemplary series 110 of wrapping paper 112a, 112b, 112c, and DIY paper bow templates, 114a, 114b, 114c, 114d, are shown. In one example, the first paper design 112a, second paper design 112b, and third paper design 112c, are examples of three different wrapping paper patterns having the same DIY design template 20 repeated at desired increments along the bottom side 12b of the gift wrap rolls 10. In this example, the DIY template content 20 corresponds to different bow designs, although it will be understood that these same features can be used with any of the aforementioned designs or any other appropriate designs. One or more portions of the template content 36 may be cut out from the DIY design templates 20 on each of the three different paper patterns, 112a, 112b, 112c, and used to construct interchangeable bow components. For example, bow 114a uses papers 112a and 112b, bow 114b uses papers 112a and 112c, bow 114c uses papers 112b and 112c, and bow 114d uses paper 112b only. In this way, different printed patterns or paper designs and colors of gift wrap rolls 10 can be coordinated with different template designs 24. As exemplified in FIG. 7, also provided herein is a kit comprising a series 110 of coordinated gift roll wraps 10. The kit may include additional instructions on how to coordinate template features, or the user can combine templates and designs independently.

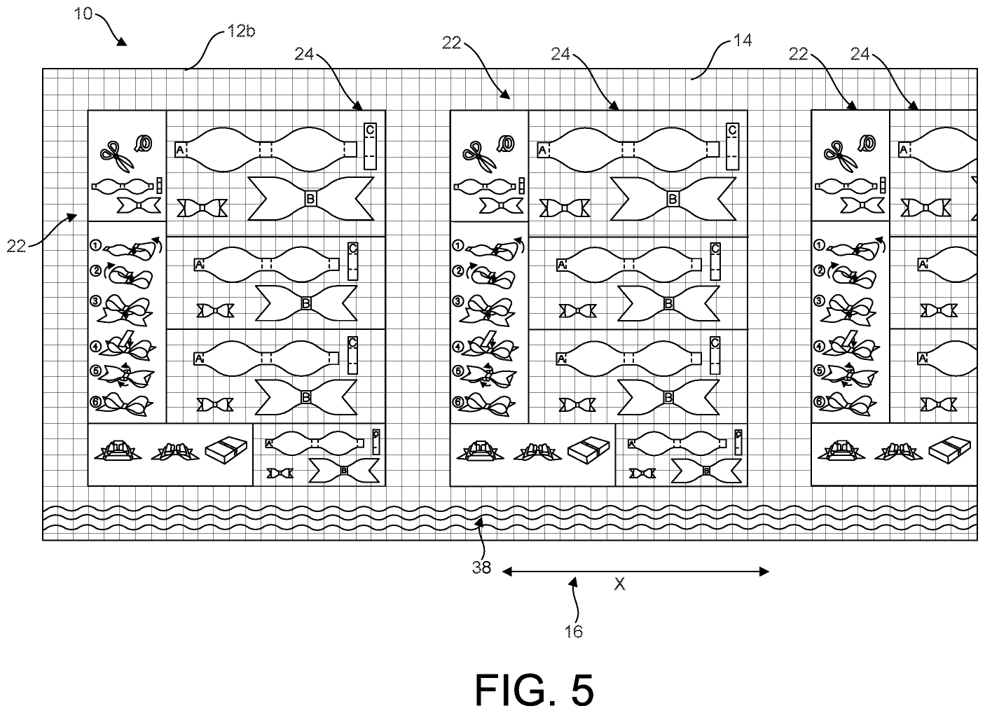

Accordingly, a continuous sheet of wrapping paper 10, shown from a back view (i.e., bottom side 12b) in FIG. 5, may include a repeated series of DIY design templates 20, which repeats the instructions and templates for a particular DIY project over the X-axis 16. As will be understood, any number of different DIY design templates 20 may be integrated in context of the gridded cut lines 14 along the X-axis 16, and the repeated pattern depicted here is one example of the types of patterns, function, or features of the possible design template content. In other embodiments, it is possible that the entire DIY design template 20 is not repeated but, for example, that the template section 24 is repeated continuously and the instructions section 22 is repeated at regular intervals (e.g., every two to three repeats of the template section 24).

Accordingly, embodiments of the disclosure relate to a roll of wrapping paper 10 printed with a decorative front side 12a, and a template section 24 with cut lines 40a on the reverse (bottom) side 12b, such that without having to purchase a separate bow or accessory item to coordinate with the intended package, the user may utilize the single wrapping paper medium for creating coordinating package coverings, package accessories, party supplies, or other decorative or fashion features.

In further aspects, the integrated grid cut lines 14 may direct the printing orientation with respect to one or both of the X-axis 16 and the Y-axis 18, during production of the roll wrap, to properly register the DIY template design 20 with one or more design components from the front side 12a. In this way, the template section 24 may be oriented such that certain templates 36 correlate with specific design features on the front side 12a of the gift wrap roll 10. That is, the DIY design template 20 can be aligned with the grid 14 and/or the axes 16, 18, and printed in a continuous fashion in order to align the design template 20 with the gift wrap roll design (i.e., particular design features on the front side 12a of the gift wrap roll 10). For example, the completed project 48 of FIG. 12 comprises a gift wrap bow having a striped design. It may be desired to align the stripes of the different project template pieces so that the design appears continuous over different pieces of the bow. The completed bow also has the stripes positioned in a diagonal orientation (as opposed to vertical stripes or horizontal stripes). In order to achieve this effect, the templates 36 on the bottom side 12b may be arranged to provide diagonal stripe alignment on the completed bow. The skilled person will understand that there are many design possibilities that can be achieved through different arrangements of the template pieces, and are not limited to striped designs only.

In this way, the bottom side 12b of the gift wrap roll 10 has an alignment (registration) key that, during production, enables alignment of the DIY design template 20 with front side 12a features. Even without coordinating alignment with top side 12a features, the alignment key (e.g., grid lines 14) may help facilitate alignment of the DIY design template 20 on the gift wrap roll 10 itself. That is, the grid lines 14 are aligned relative to the edges of the gift wrap roll 10 (e.g., horizontal lines of grid 14 are aligned with the X-axis 16 and vertical lines of the grid 14 are aligned with the Y-axis 18). By aligning certain components (e.g., DIY design template 20) with the grid 14, all components of the bottom side 12b of the gift wrap roll 10 will also be aligned.

In further embodiments, and as described at least in part above, the template section 24 may include different shapes and sizes of bows, creating multiple different bow shapes within one DIY design template 24. In further aspects, the template section 24 may include cut lines for gift tags, gift cards, envelope liner insert templates, envelope templates, and other related paper design templates. Accordingly, the instruction section 22 may include references to various assembly instructions for the different types of template content 36. As such, the informational section 32 may include bow, tag, card, envelope, and other paper component inspiration that, based on the orientation of each template within the gridded cut lines on the wrapping paper back side 12b, may produce a different design impact featuring different decorative elements from the front printed content 12a.

Also provided herein is a method of making a roll wrap paper sheet. The method comprises creating a decoration for a first side (i.e., top side 12a) of the roll wrap paper sheet 10. For example, and not limited by the figures, the top side decoration can be stripes, polka dots, or any other desired pattern or illustration. In general, the decoration comprises at least one color, or at least one design element, or at least one color and at least one design element. The method also comprises creating a DIY project template for a second side (i.e., bottom side 12b) of the roll wrap paper sheet 10, wherein the bottom side 12b is opposite the top side 12a, as described above. The DIY project template includes alignment lines and at least one design template. The template can include any template described above, for example, a bow, a gift box, a gift tag, a gift accessory, a party decoration, a home decoration, and/or a fashion accessory. The bottom side 12b can include any number of desired templates, and each template does not have to be directed to the same DIY project. In various aspects, there are at least two different design templates (e.g., a first design template and a second design template), and the first design template corresponds to a first design element of the decoration for the first side 12a of the roll wrap paper sheet 10 and the second design template corresponds to a second design element of the decoration for the first side 12a of the roll wrap paper sheet 10.

The alignment lines are described in more detail above and can comprise, for example, grid lines 14 or any other alignment key that aligns the DIY project template 20 with the top side 12a of the roll wrap paper sheet 10. The alignment lines are positioned on the bottom side 12b of the roll wrap paper sheet 10 relative to the design template 36 such that aligning the alignment lines in a pre-defined alignment position relative to the paper sheet 10 orients at least a portion of the at least one design template relative to corresponding portions of the decoration of the top side 12a of the paper sheet 10 in a pre-defined decoration position (e.g., where certain components of the top side 12a decoration are featured in a certain way or in pre-selected areas of the completed project).

The method further comprises imprinting the first side (top side 12a) of the roll wrap paper sheet 10 with the decoration, and imprinting the second side (bottom side 12b) of the roll wrap paper sheet 10 with the DIY project template such that the alignment lines are positioned in the pre-defined alignment position relative to the paper sheet 10. The decoration and DIY project template can be imprinted on the paper sheet 10 through any means known in the art. Imprinting the first side 12a of the roll wrap paper sheet 10 with the decoration can entail beginning printing on the first side proximate a leading edge of the roll wrap paper sheet 10. Similarly, imprinting the second side 12b of the roll wrap paper sheet 10 with the DIY project template 20 can entail beginning printing on the second side proximate the leading edge of the roll wrap paper sheet 10. The imprinting on the first and/or second sides can be repeated such that the roll wrap paper sheet 10 comprises a plurality of predefined decoration positions opposite a plurality of predefined design templates.

Since many possible embodiments may be made of the technology described herein without departing from the scope thereof, it is to be understood that all matter herein set forth or shown in the accompanying drawings is to be interpreted as illustrative and not in a limiting sense. Alternatively, the aspects described throughout this specification are intended in all respects to be illustrative rather than restrictive. Upon reading the present disclosure, alternative aspects will become apparent to ordinary skilled artisans that practice in areas relevant to the described aspects without departing from the scope of this disclosure. In addition, aspects of this technology are adapted to achieve certain features and possible advantages set forth throughout this disclosure, together with other advantages which are inherent. It will be understood that certain features and subcombinations are of utility and may be employed without reference to other features and subcombinations. This is contemplated by and is within the scope of the claims.

The invention claimed is:

1. A roll wrap paper sheet comprising:
a first surface comprising at least one design element; and
a second surface opposite the first surface, wherein the second surface comprises a DIY project template for making at least one DIY project, wherein the DIY project template comprises at least one design template opposite at least a portion of the at least one design element, wherein the at least one design template comprises template cut lines that define a shaped area, and wherein the template cut lines are positioned relative to corresponding portions of the at least one design element such that portions of the design element are oriented in a pre-defined decoration position within the shaped area.

2. The roll wrap paper sheet of claim 1, wherein the second surface additionally comprises at least one alignment key oriented relative to the at least one design template and to the paper sheet in a pre-defined alignment position.

3. The roll wrap paper sheet of claim 2, wherein the at least one alignment key comprising at least one line oriented parallel an outer edge of the roll wrap paper sheet.

4. The roll wrap sheet of claim 2, wherein the at least one alignment key comprises a plurality of grid lines consisting of horizontal straight lines and vertical straight lines extending along at least a portion of the second surface generally parallel to corresponding horizontal and vertical outer edges of the roll wrap paper sheet.

5. The roll wrap sheet of claim 1, wherein the DIY project template comprises a plurality of design templates comprising cut lines that define a plurality of shaped areas.

6. The roll wrap sheet of claim 5, wherein at least one of the plurality of design templates comprises template cut lines that define a first shaped area and at least one of the plurality of design templates comprises template cut lines that define a second shaped area that is different in size, shape, or size and shape from the first shaped area.

7. The roll wrap sheet of claim 1, wherein the at least one DIY project is selected from the group consisting of a bow, a gift box, a gift tag, a gift accessory, a party decoration, a home decoration, and a fashion accessory.

8. The roll wrap sheet of claim 1, wherein the at least one DIY project is a bow.

9. The roll wrap sheet of claim 1, wherein the DIY project template additionally comprises an instructions section.

10. A gridded roll wrap comprising:
a first decorated surface; and
a second surface opposite the first decorated surface, the second surface comprising a plurality of grid lines, at least one design template, and instructions;
wherein the at least one design template comprises a plurality of cut lines that define a plurality of shapes, and the instructions provide instructions for assembling the plurality of shapes into at least one project.

11. The gridded roll wrap of claim 10, wherein the at least one project is selected from the group consisting of a bow, a gift box, a gift tag, a gift accessory, a party decoration, a home decoration, and a fashion accessory.

12. The gridded roll wrap of claim 10, wherein the at least one project is a bow.

13. A roll wrap templating system comprising:
a first set of printing content configured to imprint a design on a first side of a roll of paper;
a second set of printing content configured to imprint a design template on a second side of the roll of paper; and
a registration key configured to orient at least a portion of the first set of printing content with at least a portion of the second set of printing content such that the design template is oriented on the second side of the roll of paper relative to corresponding portions of the design on the first side of the roll of paper.

14. The roll wrap templating system of claim 13, wherein the registration key comprises grid lines and wherein the second set of printing content is configured to imprint grid lines on the second side of the roll of paper in a position relative to the design template such that aligning the grid lines in a pre-defined position relative to the roll of paper orients the design template relative to corresponding positions of the design in a pre-defined position.

15. A method of making a roll wrap paper sheet comprising:
creating a decoration for a first side of the roll wrap paper sheet;
creating a DIY project template for a second side of the roll wrap paper sheet opposite the first side, wherein the DIY project template comprises alignment lines and at least one design template, wherein the alignment lines are positioned relative to the design template such that aligning the alignment lines in a pre-defined alignment position relative to the paper sheet orients at least a portion of the at least one design template relative to corresponding portions of the decoration in a pre-defined decoration position;
imprinting the first side of the roll wrap paper sheet with the decoration;
imprinting the second side of the roll wrap paper sheet with the DIY project template such that the alignment lines are positioned in the pre-defined alignment position relative to the paper sheet.

16. The method of claim 15, wherein the decoration comprises at least one color, or at least one design element, or at least one color and at least one design element.

17. The method of claim 15, wherein the alignment lines comprise grid lines consisting of horizontal and vertical lines that intersect and wherein the step of imprinting the second side of the roll wrap paper sheet comprises aligning the horizontal lines generally parallel a horizontal edge of roll wrap paper sheet and aligning the vertical lines generally parallel a vertical edge of the roll wrap paper sheet.

18. The method of claim 15, wherein imprinting the first side of the roll wrap paper sheet with the decoration comprises beginning printing on the first side proximate a leading edge of the roll wrap paper sheet, and further wherein imprinting the second side of the roll wrap paper sheet with the DIY project template comprises beginning printing on the second side proximate the leading edge of the roll wrap paper sheet.

19. The method of claim 18, further comprising repeating imprinting the first side with the decoration and the second side with the DIY project template such that the roll wrap paper sheet comprises a plurality of predefined decoration positions opposite a plurality of predefined design templates.

20. The method of claim 15, wherein the at least one design template comprises a first design template and second design template, and further wherein the first design template corresponds to a first design element of the decoration for the first side and the second design template corresponds to a second design element of the decoration for the first side, wherein the first design element is different than the second design element.
